(19) United States
(12) Patent Application Publication
(10) Pub. No.: US 2014/0212098 A1
(43) Pub. Date: Jul. 31, 2014

(54) OPTICAL CONNECTOR

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/014,377

(22) Filed: Aug. 30, 2013

(30) Foreign Application Priority Data
Jan. 28, 2013 (TW) 102103221

(51) Int. Cl. G02B 6/43

(52) U.S. Cl. CPC G02B 6/43
USPC 385/89

(57) ABSTRACT

An optical connector includes a photoelectric unit and a lens unit positioned on the photoelectric unit. The lens unit includes a first surface facing toward the photoelectric unit and a number of protrusions protruding from the first surface. The protrusions are spaced from each other.

### BACKGROUND

1. Technical Field

The present disclosure relates to communication apparatus, and particularly to an optical connector.

2. Description of Related Art

Optical connectors include a substrate, a photoelectric unit, a lens unit, and a jumper. The photoelectric unit and the lens unit are positioned on the substrate and the lens unit covers the photoelectric element such that lenses formed on the lens unit are aligned with photoelectric elements of the photoelectric unit. The lens unit is fixed to the substrate using adhesive. However, if the lens unit needs to engage with the jumper after fixing, it may be knocked out of alignment with the photoelectric unit during the engagement.

Therefore, what is needed is an optical connector addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an assembled, isometric view of an optical connector according to one embodiment.

FIG. 2 is an exploded view of the optical connector of the FIG. 1.

FIG. 3 is similar to FIG. 1, but shows the optical connector from another angle.

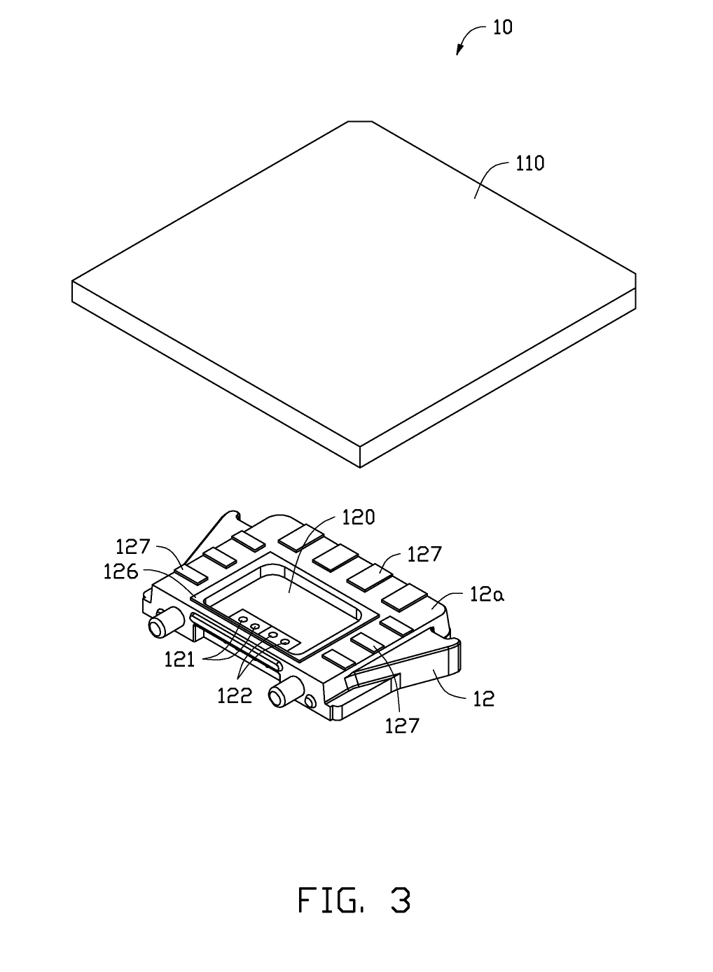

### DETAILED DESCRIPTION

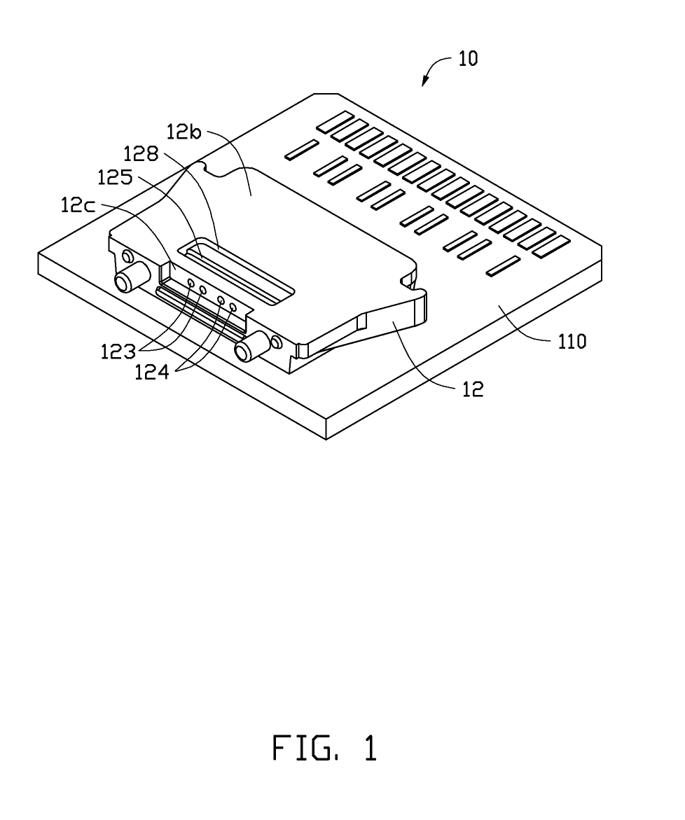

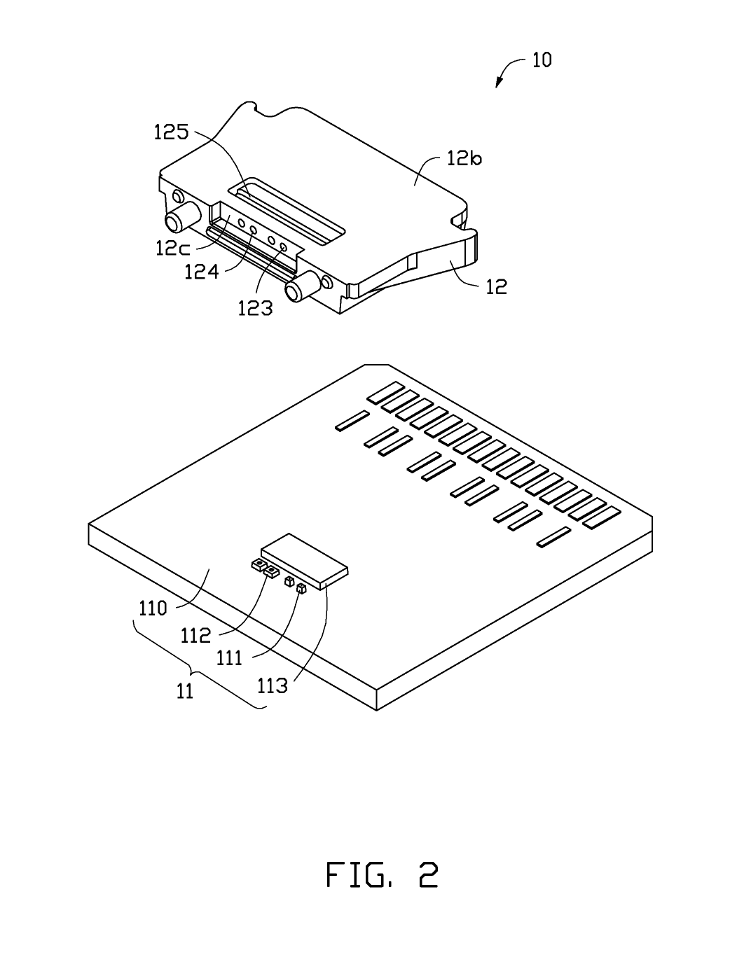

FIGS. 1-2 show one embodiment of an optical connector 10. The optical connector 10 includes a photoelectric unit 11 and a lens unit 12 positioned on the photoelectric unit 11.

The photoelectric unit 11 includes a substrate 110, a number of emitters 111 positioned on the substrate 110, a number of receivers 112 positioned on the substrate 110, and a driver chip 113 positioned on the substrate 110. In this embodiment, the substrate 110 is a printed circuit board (PCB), such as rigid PCB or flexible PCB (FPCB). The emitters 111 are configured for generating and emitting light in the form of optical signals, and the receivers 112 are configured for receiving light in the form of optical signals and converting the optical signals into electrical signals. In this embodiment, the emitters 111 can be light emitting diodes or laser diodes, and the receivers 112 are photodiodes. The driver chip 113 is electrically connected to the emitters 111 and the receivers 112 for driving the emitters 111 and receivers 112 to emit/receive optical signals.

The lens unit 12 is fixed to the substrate 110. The lens unit 12 includes a first surface 12a facing toward the substrate 110, a second surface 12b opposite to the first surface 12a, and a third surface 12c perpendicularly connected to the first surface 12a and the second surface 12b. The lens unit 12 defines a recess 120 in the first surface 12a. The lens unit 12 includes a number of first lenses 121 corresponding to the emitters 111, a number of second lenses 122 corresponding to the receivers 112, a number of third lenses 123 corresponding to the first lenses 121, and a number of fourth lenses 124 corresponding to the second lenses 122. The first and second lenses 121, 122 are formed on a bottom surface of the recess 120, and the third and fourth lenses 123, 124 are formed on the third surface 12b. An optical axis of each of the first and second lenses 121, 122 is substantially perpendicular to the first surface 12a, and an optical axis of each of the third and fourth lenses 123, 124 is substantially perpendicular to the third surface 12c.

The lens unit 12 includes a reflecting surface 125. An angle between the reflecting surface 125 and the optical axis of each of the first, second, third, and fourth lenses 121, 122, 123, 124 is substantially 45 degrees. In this embodiment, the reflecting surface 125 is formed in a groove 128 defined in the second surface 12b.

The lens unit 12 includes a number of protrusions 127 protruding from the first surface 12a. The protrusions 127 are spaced from each other. The protrusions 127 have a same height relative to the first surface 12a. In this embodiment, each protrusion 127 is substantially rectangular. A shape of each protrusion 127 can be changed according to different needs. The lens unit 12 further includes a block wall 126 protruding from the first surface 12a and continuously surrounding an opening of the recess 120. A height of the block wall 126 relative to the first surface 12a is not less than that of the protrusions 127.

In assembly, the lens unit 12 is positioned on the substrate 110 and covers the emitters 111, the receivers 112, and the driver chip 113, in the recess 120. The emitters 111 are aligned with the first lenses 121, and the receivers 122 are aligned with the second lenses 122. The lens unit 12 is fixed to the substrate 110 by an adhesive (not shown) applied between the lens unit 12 and the substrate 110. Because of the protrusions 127 of the lens unit 12, a greater amount of the adhesive can be distributed between the lens unit 12 and the substrate 110, therefore, a larger jointing area between the lens unit 12 and the substrate 110 is thus created and more force can be applied to ensure a steady and stable assembling of the lens unit 12. In addition, a space between adjacent protrusions 12 provides an overflow space for the adhesive. Furthermore, the block wall 126 prevents the adhesive flowing into recess 120 during an assembling process of the lens unit 12, thus keeping the emitters 111, the receivers 112, and the driver chip 113 from being marked or contaminated by the adhesive.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. An optical connector, comprising:
a photoelectric unit; and
a lens unit positioned on the photoelectric unit f, the lens comprising a first surface facing toward the photoelectric unit and a plurality of protrusions protruding from the first surface, the protrusions being spaced apart from each other.

2. The optical connector of claim 1, wherein the photoelectric unit comprises a substrate, a plurality of emitters for emitting optical signals, a plurality of receivers for receiving optical signals, and a driver chip, all of the emitters, the receivers, and the driver chip are positioned on the substrate, and the driver chip is electrically connected to the emitters and the receivers for driving the emitters and the receivers.

3. The optical connector of claim 2, wherein the lens unit defines a recess in the first surface, the lens unit is positioned on the substrate and covers the emitters, the receivers, and the driver chip in the recess.

4. The optical connector of claim 3, wherein the lens unit comprises a block wall protruding from the first surface and continuously surrounding an opening of the recess.

5. The optical connector of claim 4, wherein a height of the block wall relative to the first surface is no less than a height of the protrusions relative to the first surface.

6. The optical connector of claim 3, wherein the lens unit comprises a plurality of first lenses spatially corresponding to the emitters and a plurality of second lenses spatially corresponding to the receivers, the first lenses and the second lenses are formed on a bottom surface of the recess, the first lenses are respectively aligned with the emitters, and the second lenses are respectively aligned with receivers.

7. The optical connector of claim 6, wherein the lens unit comprises a second surface opposite to the first surface, a third surface substantially perpendicularly connected to the first surface and the second surface, and a reflecting surface for reflecting optical signals between the first surface and the second surface.

8. The optical connector of claim 7, wherein the lens unit defines a groove in the second surface, and the reflecting surface is formed in the groove.

9. The optical connector of claim 6, wherein the lens unit comprises a plurality of third lenses corresponding to the first lenses and a number of fourth lenses corresponding to the second lenses, the third lenses and the fourth lenses are formed on the third surface.

10. The optical connector of claim 9, wherein an optical axis of each of the first and second lenses is substantially perpendicular to the first surface, and an optical axis of each of the third and fourth lenses is substantially perpendicular to the third surface.

11. The optical connector of claim 10, wherein an angle between the reflecting surface and the optical axis of each of the first, second, third, and fourth lenses is substantially 45 degrees.
